(19) United States
(12) Patent Application Publication
(10) Pub. No.: US 2011/0103727 A1
(43) Pub. Date: May 5, 2011

(54) ARRANGEMENT AND PROCESS FOR MOUNTING AN AXIAL BEARING IN A HERMETIC COMPRESSOR

(76) Inventors: Milton Wetzel Pereira, Joinville-Sc (BR); Emerson Moreira, Joinville-Sc (BR); Fabian Fagotti, Joinville-Sc (BR); Gustavo Cardoso Weber, Joinville-Sc (BR); Ricardo Maciel, Joinville-Sc (BR)

(21) Appl. No.: 12/933,495

(22) PCT Filed: Mar. 18, 2009
(86) PCT No.: PCT/BR2009/000074

§ 371 Date: Dec. 15, 2010

(30) Foreign Application Priority Data
Mar. 19, 2008 (BR) PI0801103-6

(51) Int. Cl. F04B 53/00; B23P 11/00; F16C 17/10

(52) U.S. Cl. 384/416; 29/888.02

(57) ABSTRACT

The invention is applied to a compressor comprising: a cylinder block (10) provided with a radial bearing (11) and an axial bearing (12); an eccentric shaft (20) having an upper end extension (21), around which a rotor (30) is mounted and supported on the axial bearing (12). A sliding ring (40) is mounted around said upper end extension (21), which is provided with an indexing means (22) to which is coupled a positioning means (42) of the sliding ring (40), rotatively locking the latter to the eccentric shaft (20). The mounting process comprises the steps of: mounting the eccentric shaft (20) in the radial bearing (11); descendingly mounting the sliding ring (40) around the upper end extension (21) of the eccentric shaft (20), until reaching an axial positioning stop (22c) therein, rotationally locking the sliding ring (40) to the eccentric shaft (20); and mounting the rotor (30) to the eccentric shaft (20) until seating a lower face portion (32) of the rotor (30) on the sliding ring (40).

### FIELD OF THE INVENTION

The present invention refers to an arrangement and a process for mounting an axial bearing in a reciprocating hermetic compressor with a vertical shaft, of the type used in small refrigeration systems and in which the electric motor rotor is mounted to the eccentric shaft, above the cylinder block, to be axially supported on the latter.

### BACKGROUND OF THE INVENTION

Hermetic refrigeration compressors of the type considered above, present, mounted inside a hermetically sealed shell, a cylinder block in which the eccentric shaft is radially journalled and which axially supports the electric motor rotor attached to the eccentric shaft, above the cylinder block.

The weight of the crankshaft-rotor assembly is supported by an axial bearing, which generally comprises an annular upper end surface of the cylinder block and at least one sliding ring, to be disposed between the upper end surface of the cylinder block and an annular portion of the lower end face of the electric motor rotor.

The crankshaft carries, in its lower end, a pump rotor which, during the operation of the compressor, conducts lubricant oil from a reservoir, defined in the lower portion of the shell, to the parts with mutual relative movement, so as to guarantee oil supply for the correct operation of said parts.

In order to prevent relative rotational movement between the lower end face of the rotor and the sliding ring of the axial bearing, the latter needs to be rotationally locked in relation to the crankshaft-rotor assembly.

In the currently known constructive solutions, the rotational locking of the sliding ring in relation to the crankshaft-rotor assembly is made by providing the sliding ring with one or more coplanar outer radial teeth that are dimensioned to be fitted in respective inner radial recesses provided close to the lower end face of the rotor, the depth of the radial recesses being dimensioned to guarantee the desired rotational locking of the sliding ring and to permit the outer face of the sliding ring, turned to the cylinder block, to be seated and supported thereon, avoiding the contact between the rotor and the cylinder block. This type of mounting is usually applied in axial bearings which use one or more sliding rings, cooperating or not with intermediary spheres, since the technical problem to be solved concerns the rotational locking of the sliding ring, which will be seated against the rotor, to the crankshaft-rotor assembly.

Although being largely used and providing an adequate axial bearing for the crankshaft-rotor assembly, this prior art construction presents the inconvenience of requiring the provision of the radial recesses in the rotor, in order to obtain the rotational locking of the adjacent sliding ring. The operations of machining the rotor or of stamping the end laminations of the lamination stack of the rotor with a specific configuration for obtaining said radial recesses raise the production costs.

Another drawback of the previous solution mentioned above results from the difficulty in maintaining the sliding ring positioned seated against the lower end face of the rotor during the mounting step in which the generally heated rotor is descendingly displaced to be fitted, by interference, around an upper extension of the eccentric shaft.

### SUMMARY OF THE INVENTION

It is, therefore, an object of the present invention to provide an arrangement and a process for mounting an axial bearing in a reciprocating hermetic refrigeration compressor, of the type considered above and which allows a substantial constructive and assembling simplification of the parts for bearing the crankshaft-rotor assembly to the cylinder block and for the rotational locking of the sliding ring to said crankshaft-rotor assembly.

The present invention is applied to a reciprocating hermetic compressor of the type which comprises: a cylinder block provided with a radial bearing and an upper axial bearing; an eccentric shaft journalled in the radial bearing and having an upper end extension projecting upwardly from the axial bearing; a rotor of an electric motor having a lower face portion and being mounted and rotatively axially locked around the upper end extension of the eccentric shaft, in order to have its lower face portion supported on the axial bearing.

According to an aspect of the invention, the mounting arrangement comprises a sliding ring mounted around the upper end extension of the eccentric shaft, between the axial bearing and the lower face portion of the rotor, said upper end extension of the eccentric shaft being provided with an indexing means and said sliding ring carrying a positioning means to be coupled to the indexing means, so as to rotatively lock the sliding ring to the eccentric shaft.

The construction described above allows using only one sliding ring provided with a single positioning means, such as a single coplanar inner radial tooth, which is fitted in an indexing means, for example, in the form of an indexing channel produced along a certain longitudinal upper end extension of the eccentric shaft. Thus, the sliding ring can be mounted to the eccentric shaft and gravitationally maintained in the mounting position, already rotatively locked to the latter, permitting the rotor to be subsequently mounted, by interference, around the upper end extension of the eccentric shaft, without requiring previous fixation of the sliding ring in the lower face portion of the rotor, as it occurs in the prior art described above.

Another advantageous aspect of the present solution is the possibility of using only one sliding ring, which us easily and rotatively locked to the eccentric shaft, without requiring the provision of multiple sliding rings, associated or not with intermediary spheres. Said sliding ring is usually made in metallic material and can be optionally injected in engineering plastic or also in additivated “Teflon”, complying with the requirements of low friction and wear resistance at a lower cost.

Further according to another aspect of the present invention, the mounting arrangement is carried out with a process for mounting an axial bearing in a reciprocating hermetic compressor of the type defined above, said process comprising the steps of: mounting the eccentric shaft in the interior of the radial bearing of the cylinder block and axially immobilizing it in a predetermined position, in which its upper end extension projects beyond the axial bearing; maintaining the cylinder block immobilized in a position in which the upper end extension of the eccentric shaft projects upwardly from the axial bearing; descendingly mounting the sliding ring around the upper end extension of the eccentric shaft, until reaching an axial positioning stop therein, in order to provide the rotational locking of the sliding ring to the eccentric shaft; and mounting and rotatively axially locking the rotor around the upper end extension of the eccentric shaft, with the lower face portion of said rotor seated on the sliding ring.

### BRIEF DESCRIPTION OF THE DRAWINGS

The invention will be described below, with reference to the enclosed drawings, given by way of example of a possible embodiment of the invention and in which:

FIG. 1 represents a partial median vertical sectional view of a reciprocating hermetic compressor mounted according to the prior art and illustrating, in an exploded way, the eccentric shaft supported on the cylinder block; the stator; the rotor; and the sliding ring;

FIG. 1A represents an enlarged view of the region for mounting, to the eccentric shaft, the electric motor rotor disposed above the cylinder block, as illustrated in FIG. 1;

FIG. 2 represents a cross-sectional view of the compressor mounted according to the prior art, taken according to line II-II indicated in FIG. 1A, in the region for seating the rotor to the cylinder block and incorporating a sliding ring mounted to the rotor and constructed according to the prior art;

FIGS. 3 and 3a represent, schematically and respectively, a lower perspective view and an upper perspective view of the eccentric shaft in an inverted position, carrying the positioning means of the present invention;

FIG. 4 represents a partial median vertical sectional view of a reciprocating hermetic compressor, such as that of FIG. 1, for the construction of the present invention;

FIG. 4A represents an enlarged view of the region for mounting, to the eccentric shaft, the electric motor rotor disposed above the cylinder block, as illustrated in FIG. 4; and

FIG. 5 represents a cross-sectional view of the compressor mounted according to the present invention, taken according to line V-V indicated in FIG. 4A, in the region for seating the rotor to the cylinder block and incorporating a sliding ring mounted to the rotor and constructed according to the present invention.

### DETAILED DESCRIPTION OF THE INVENTION

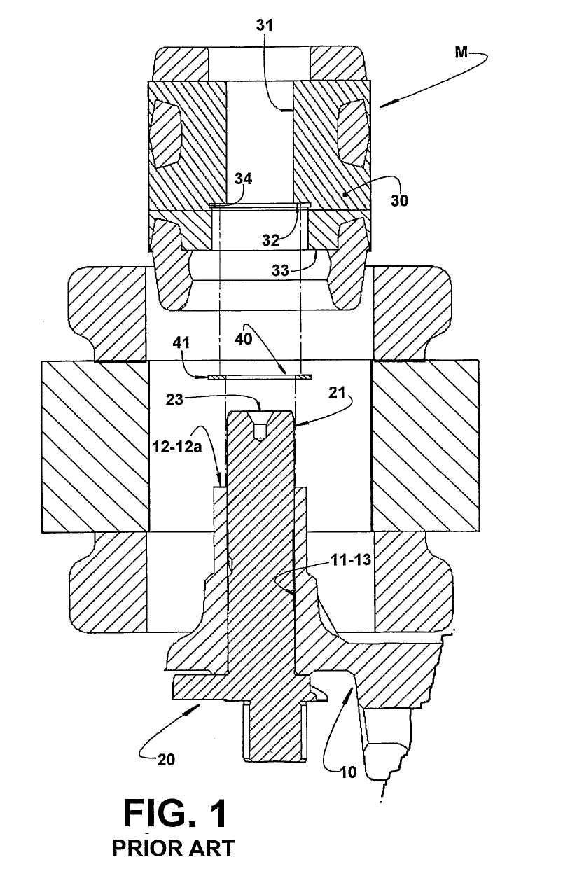

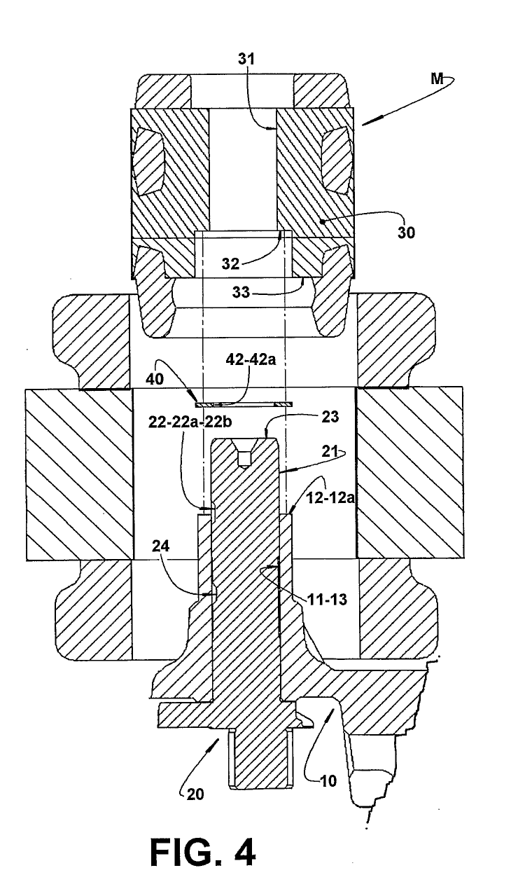

As already previously mentioned, the present invention is applied to a reciprocating hermetic compressor of the type illustrated in FIGS. 1, 1A, 4 and 4A of the enclosed drawings and which comprises: a cylinder block 10 provided with a radial bearing 11 and an axial bearing which, in the construction illustrated in the drawings, comprises an upper annular surface 12a of the cylinder block 10 itself; and a vertical eccentric shaft 20 journalled in the interior of the radial bearing 11 and having an upper end extension 21 projecting upwardly from the upper annular surface 12a of the cylinder block 10. In the constructive example illustrated in the enclosed drawings, the radial bearing 11 is defined in a cylindrical through-hole 13 of the cylinder block 10.

In the illustrated constructions, the eccentric shaft 20 attaches a rotor 30 of an electric motor M disposed above the cylinder block 10. The rotor 30 is formed from the vertical alignment of a plurality of annular metallic laminations which define together, and in their inner peripheral edges, an inner cylindrical surface 31 of the rotor 30, the latter also having an annular lower face portion 32 adjacent to the inner cylindrical surface 31 of the rotor 30.

The rotor 30 is mounted around the upper end extension 21 of the eccentric shaft 20, so as to have its lower face portion 32 supported on the axial bearing 12.

In the illustrated example, the lower face portion 32 of the rotor 30 is axially spaced back in relation to a lower end face 33 of the lamination stack of the rotor 30.

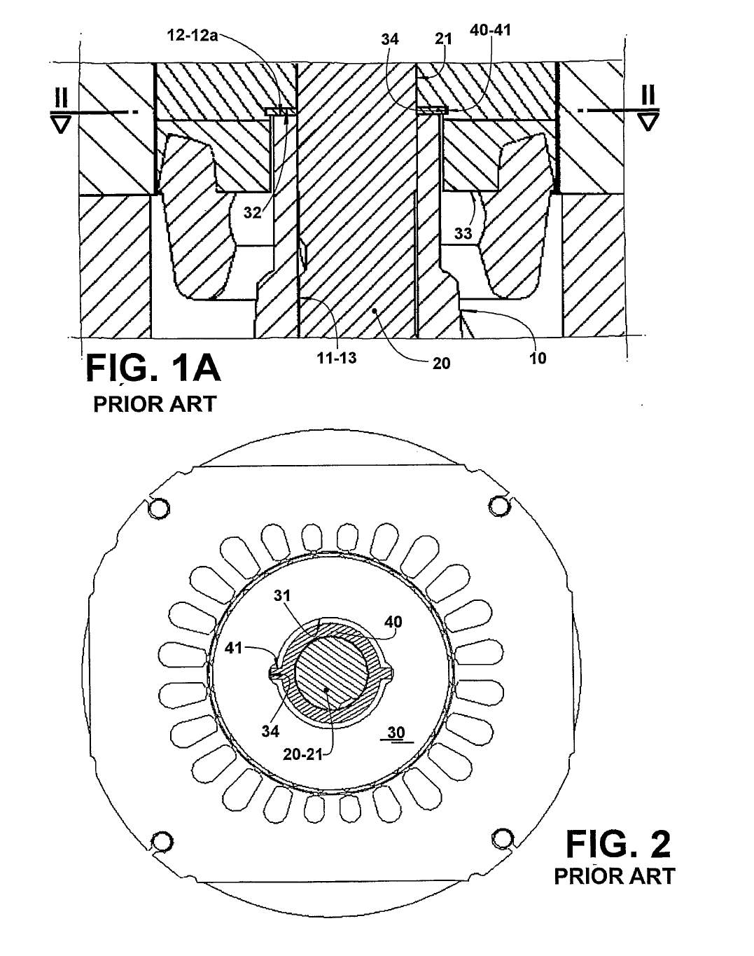

In the prior art construction, illustrated in FIGS. 1, 1A and 2, for mounting the rotor 30 to the assembly defined by the cylinder block 10 and eccentric shaft 20, the rotor 30 is previously machined to provide, in its inner cylindrical surface 31, at least two radial slots 34, made from the lower face portion 32 defined in the lamination stack of the rotor 30 and in which are fitted and rotatively locked respective outer radial projections 41 of a sliding ring 40, which is axially seated against said lower face portion 32 and against the upper annular surface 12a of the cylinder block 10.

After the necessary and laborious retention of the sliding ring 40 to the rotor 30, the latter can be descendingly mounted and attached, generally by interference, in the upper end extension 21 of the eccentric shaft 20, without occurring loss of positioning of the sliding ring 40 in relation to the parts of eccentric shaft 20 and rotor 30. This construction presents the advantages already previously discussed.

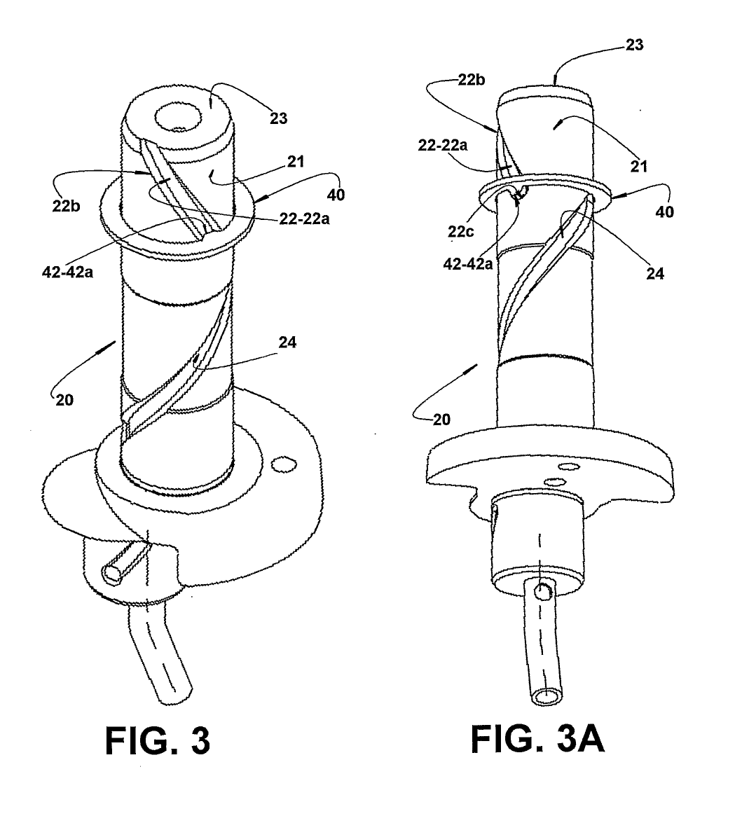

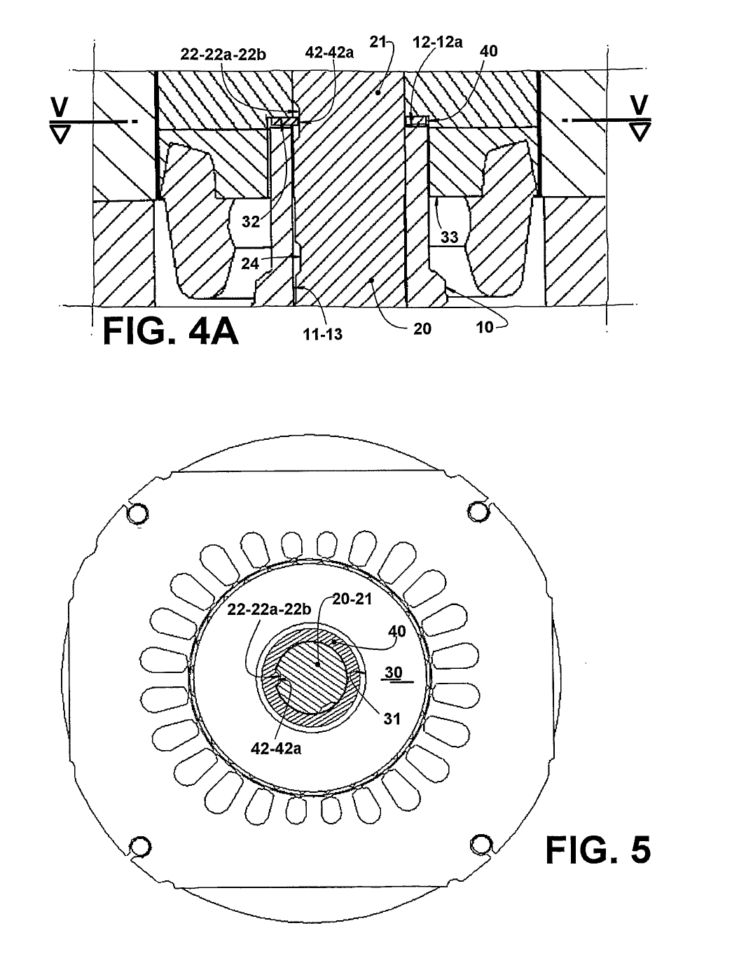

The present invention, as exemplarily illustrated in FIGS. 3-5, provides an arrangement for mounting an axial bearing in a reciprocating hermetic compressor of the type described above, said arrangement comprising a sliding ring 40 mounted around the upper end extension 21 of the eccentric shaft 20, between the axial bearing 12 and the lower face portion 32 of the rotor 30, said upper end extension 21 of the eccentric shaft 20 being provided with an indexing means 22 and said sliding ring 40 carrying a positioning means 42 to be coupled to the indexing means 22, so as to rotatively lock the sliding ring 40 in the eccentric shaft 20.

In a way of carrying out the present invention, the indexing means 22 is defined by an indexing recess 22a and the positioning means 42 is in the form of an inner radial tooth 42a incorporated to the sliding ring 40. The sliding ring 40 can be constructed in a metallic material, injected in engineering plastic or also in additivated “Teflon”, complying with the requirements of low friction and wear resistance at a lower cost.

In the illustrated construction, the inner radial tooth 42a of the sliding ring 40 is defined by a coplanar radial extension of the sliding ring 40.

In the illustrated construction, the indexing recess 22a is in the form of an indexing channel 22b, produced longitudinally and externally in the upper end extension 21 of the eccentric shaft 20, for example from a free upper end 23 of the eccentric shaft 20 and extending along the whole upper end extension 21 of the latter. For this construction, the indexing channel 22b defines, in a blind inner end, the axial positioning stop 22c of the sliding ring 40.

The indexing channel 22b of the present invention is preferably produced in helical development along the outer side surface of the upper end extension 21 of the eccentric shaft 20, particularly in a direction opposite to that of rotation of the eccentric shaft 20, so that, with said rotation, the lubricant oil existing in the region of the axial positioning stop 22c and, consequently, in the region in which the sliding ring 40 is mounted, is maintained in this region rather than being ascendingly impelled towards the free upper end 23 of the eccentric shaft 20, along said indexing channel 22b.

In the cases in which the eccentric shaft 20 presents one or more oil channels 24 produced in helical development in the outer side surface of said eccentric shaft 20, the indexing channel 22b is provided in helical development in a direction opposite to that of any helical oil channel 24 produced in said eccentric shaft 20.

It should be understood that the indexing means 22 can present constructions other than that illustrated in the enclosed drawings and which comprises the indexing channel 22b. For example, the indexing means 22 can be defined by a recess (not illustrated) produced in the eccentric shaft 20, in the axial positioning region of the sliding ring 40, the inner radial tooth 42a of the latter being fitted and rotatively locked in the interior of said recess after the sliding ring 40 has been axially descendingly displaced from the free upper end 23 of the eccentric shaft 20 until the mounting position, maintaining a certain localized elastic deformation of the assembly defined by the sliding ring 40 and inner radial tooth 42a, until the latter is fitted in said not-illustrated recess.

According to the present invention, the process for mounting the assembly defined by the rotor 30 and eccentric shaft 20 to the cylinder block 10 occurs with the generic steps of: mounting the eccentric shaft 20 in the interior of the radial bearing 11 of the cylinder block 10 and axially immobilizing it in a predetermined position, in which its upper end extension 21 projects beyond the axial bearing 12; maintaining the cylinder block 10 immobilized in a positioning in which the upper end extension 21 of the eccentric shaft 20 projects upwardly from the axial bearing 12; descendingly mounting the sliding ring 40 constructed according to the present invention, around the upper end extension 21 of the eccentric shaft 20, until reaching an axial positioning stop 22c therein, in order to provide the rotational locking of the sliding ring 40 to the eccentric shaft 20; and mounting and rotatively axially locking the rotor 30 around the upper end extension 21 of the eccentric shaft 20, until seating the lower face portion 32 of said rotor 30 on the sliding ring 40.

The step of mounting the sliding ring 40 comprises coupling the positioning means 42 of said sliding ring 40 to the indexing means 22 provided in the eccentric shaft 20, said coupling being obtained by positioning of the sliding ring 40 around the free upper end 23 of the eccentric shaft 20, which positioning is maintained until the sliding ring 40 reaches the axial positioning stop 22c. In this condition, the lower face portion 32 of the rotor 30 is seated against the sliding ring 40, which is slidingly seated against the axial bearing 12 of the cylinder block 10.

With this construction, besides obtaining a locking improvement, the oil is prevented from radially leaking through the region of the sliding ring 40, which oil leaking would impair the lubrication of the upper end extension 21 of the eccentric shaft 20.

The mounting arrangement of the present invention is related not only to the constructive modification in the sliding ring 40, as described above, but also to a determined construction and assembling of said sliding ring 40 to the eccentric shaft 20, which does not impair the correct operation of lubricating the latter.

The new constructive arrangement further allows an easier, quicker and safer mounting of the rotor 30 to the eccentric shaft 20, without requiring to provide housings for the sliding ring 40 in the rotor 30, and to attach said sliding ring 40 thereto, before placing the rotor 30 around the upper end extension 21 of the eccentric shaft 20, in order to prevent detachment of said sliding ring in relation to the rotor 30, and also to permit a substantial reduction in the respective machining time.

Although only one exemplary embodiment of the present invention has been illustrated herein, it should be understood that alterations can be made in the form and arrangements of the constitutive elements, without departing from the constructive concept defined in the claims accompanying the present specification.

1. An arrangement for mounting an axial bearing in a reciprocating hermetic compressor of the type which comprises: a cylinder block (10) provided with a radial bearing (11) and an upper axial bearing (12); an eccentric shaft (20) journalled in the radial bearing (11) and having an upper end extension (21) projecting upwardly from the axial bearing (12); a rotor (30) of an electric motor (M) having a lower face portion (32) and being mounted and rotatively axially locked around the upper end extension (21) of the eccentric shaft (20), in order to have its lower face portion (32) supported on the axial bearing (12), the arrangement being characterized in that it comprises a sliding ring (40) mounted around the upper end extension (21) of the eccentric shaft (20), between the axial bearing (12) and the lower face portion (32) of the rotor (30), said upper end extension (21) of the eccentric shaft (20) being provided with an indexing means (22) and said sliding ring (40) carrying a positioning means (42) to be coupled to the indexing means (22), in order to rotatively lock the sliding ring (40) in the eccentric shaft (20).

2. The arrangement, as set forth in claim 1, characterized in that the indexing means (22) is an indexing recess (22a) and the positioning means (42) is in the form of an inner radial tooth (43) incorporated to the sliding ring (40).

3. The arrangement, as set forth in claim 2, characterized in that the inner radial tooth (42a) of the sliding ring (40) is defined by a coplanar radial extension of the sliding ring (40).

4. The arrangement, as set forth in claim 3, characterized in that the indexing recess (22a) is in the form of an indexing channel (22b) provided longitudinally and externally in the upper end extension (21) of the eccentric shaft (20).

5. The arrangement, as set forth in claim 4, characterized in that the indexing channel (22b) is provided from a free upper end (23) of the eccentric shaft (20) and extends along the whole upper end extension (21) of the latter.

6. The arrangement, as set forth in claim 4, characterized in that the indexing channel (22b) defines, in a blind inner end, an axial positioning stop (22c) of the sliding ring (40).

7. The arrangement, as set forth in claim 4, characterized in that the indexing channel (22b) is produced in helical development in the direction opposite to the operational rotation of the eccentric shaft (20).

8. The arrangement, as set forth in claim 7, in which the eccentric shaft (20) is externally provided with at least one helical oil channel (24), characterized in that the indexing channel (22b) is provided in helical development in the direction opposite to the helical development of the said oil channel (24).

9. The arrangement, as set forth in claim 1, characterized in that the lower face portion (32) of the rotor (30) is seated against the sliding ring (40), which is slidingly seated against the axial bearing (12) of the cylinder block (10).

10. A process for mounting an axial bearing in a reciprocating hermetic compressor of the type defined in claim 1, characterized in that it comprises the steps of:
mounting the eccentric shaft (20) in the interior of the radial bearing (11) of the cylinder block (10) and axially immobilizing it in a predetermined position, in which its upper end extension (21) projects beyond the axial bearing (12);
maintaining the cylinder block (10) immobilized in a positioning in which the upper end extension (21) of the eccentric shaft (20) projects upwardly from the axial bearing (12),
descendingly mounting the sliding ring (40) around the upper end extension (21) of the eccentric shaft (20), until reaching an axial positioning stop (22c) therein, in order to provide the rotational locking of the sliding ring (40) to the eccentric shaft (20); and
mounting and rotatively axially locking the rotor (30) around the upper end extension (21) of the eccentric shaft (20), with the lower face portion (32) of said rotor (30) seated on the sliding ring (40).

11. The process, as set forth in claim 10, characterized in that the step of mounting the sliding ring (40) comprises coupling its positioning means (42) to the indexing means (22) provided in the eccentric shaft (20).

12. The process, as set forth in claim 11, characterized in that the coupling between the positioning means (42) and the indexing means (22) is obtained by positioning the sliding ring (40) around a free upper end (23) of the eccentric shaft (20), which positioning is maintained 20 until the sliding ring (40) reaches the axial positioning stop (22c).
